(19) United States
(12) Patent Application Publication
(10) Pub. No.: US 2001/0029453 A1
(43) Pub. Date: Oct. 11, 2001

(54) Generation of a language model and of an acoustic model for a speech recognition system

(76) Inventors: Dietrich Klakow, Aachen (DE); Armin Pfersich, Breitenfurt (AT)

Correspondence Address: U.S. Philips Corporation, 580 White Plains Road, Tarrytown, NY, 10591, US

(21) Appl. No.: 09/811,653

(22) Filed: Mar. 19, 2001

(30) Foreign Application Priority Data
Mar. 24, 2000 (DE) 10014337.7

(51) Int. Cl. G10L 15/18

(52) U.S. Cl. 704/257

(57) ABSTRACT

The invention relates to a method of generating a language model and a method of generating an acoustic model for a speech recognition system. There is proposed to successively reduce the respective training material by training material portions in dependence on application-specific data or to extend it to obtain the respective training material for generating a language model and the acoustic model.

The invention relates to a method of generating a language model for a speech recognition system. The invention also relates to a method of generating an acoustic model for a speech recognition system.

For generating language models and acoustic models for speech recognition systems, there is extensive training material available which, however, is not necessairily application-specific. The training material for the generation of language models customarily comprises a collection of a number of text documents, for example, newspaper articles. The training material for the generation of an acoustic model comprises acoustic references for speech signal sections.

From WO 99/18556 is known to select certain documents from an available number of text documents with the aid of a selection criterion and use the text corpus formed from the selected documents as a basis for forming the language model. There is proposed to search for the documents on the Internet and carry out the selection in dependence on how often predefined keywords occur in the documents.

It is an object of the invention to optimize the generation of language models with a view to the best possible utilization of available training material.

The object is achieved in that a first text corpus is gradually reduced by one or various text corpus parts in dependence on text data of an application-specific second text corpus and in that the values of the language model are on the basis of the reduced first text corpus is used.

This approach leads to a user-specific language model with reduced perplexity and reduced OOV rate, which finally improves the word error rate of the speech recognition system and the computation circuitry and expenditure is kept smallest possible. Furthermore, one can thus generate a language model of smaller size, in which language model tree paths can be saved compared to a language model based on a non-reduced first text corpus, so that the required memory capacity is reduced.

Advantageous embodiments are stated in the dependent claims 2 to 6.

Another approach of the language model generation (claim 7) implies that a text corpus section of a given first text corpus is gradually extended by one or more other text corpus sections of the first text corpus in dependence on text data of an application-specific text corpus to form a second text corpus, and in that the values of the language model are generated through the use of the second text corpus. Contrary to the method described above, a large (background) text corpus is not reduced, but sections of this text corpus are gradually accumulated. This leads to a language model that has as good properties as a language model generated in accordance with the method mentioned above.

It is also an object of the invention to optimize the generation of the acoustic model of the speech recognition system with a view to the best possible use of available acoustic training material.

This object is achieved in that acoustic training material representing a first number of speech utterances is gradually reduced by training material sections representing individual speech utterances in dependence on a second number of application-specific speech utterances and in that the acoustic references of the acoustic model are formed by means of the reduced acoustic training material.

This approach leads to a smaller acoustic model having a reduced number of acoustic references. Furthermore, the acoustic model thus generated contains fewer isolated acoustic references scattered in the feature space. The acoustic model generated according to the invention finally leads to a lower word error rate of the speech recognition system.

Corresponding advantages hold for the approach that a given acoustic training material section representing a speech utterance, which training material represents many speech utterances, is gradually extended by one or more other sections of the given acoustic training material and that by means of the accumulated sections of the given acoustic training material the acoustic references of the acoustic model are formed.

Examples of embodiment of the invention will be further described and explained with reference to the drawings in which:

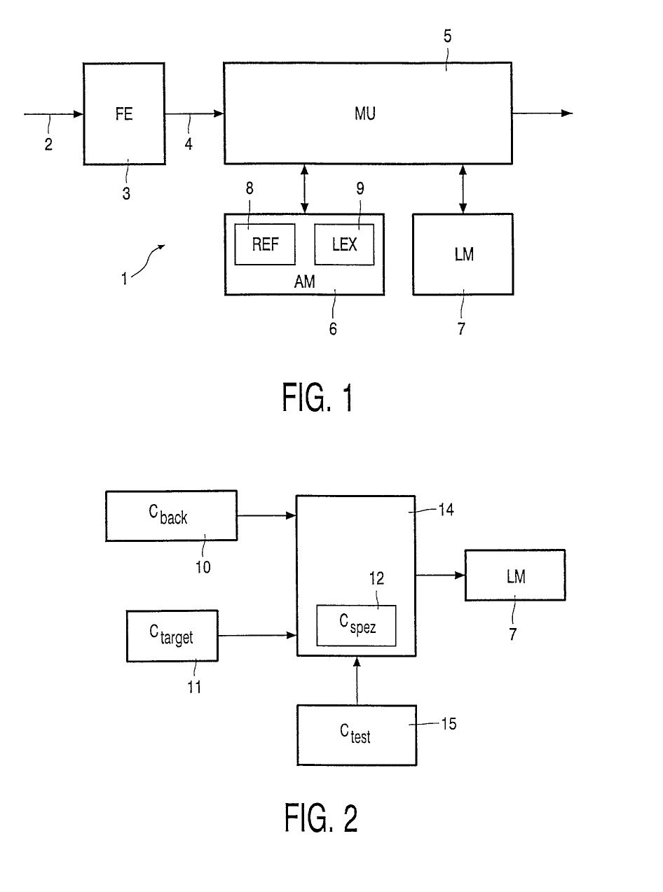

FIG. 1 shows a block diagram of a speech recognition system and

FIG. 2 shows a block diagram for generating a language model for the speech recognition system.

FIG. 1 shows the basic structure of a speech recognition system 1, more particularly of a dictating system (for example FreeSpeech by Philips). An entered speech signal 2 is input of a function unit 3, which carries out a feature extraction (FE) for this signal and then generates feature vectors 4 which are applied to a matching unit 5 (MS). In the matching unit 5, which determines and outputs the recognition result, a path is searched in known fashion while an acoustic model 6 (AM) and a language model 7 (LM) are used. The acoustic model 6 comprises, on the one hand, models for word sub-units such as, for example, triphones to which sequences of acoustic references are assigned (block 8) and a lexicon, which represents the vocabulary used and predefines possible sequences of word sub-units. The acoustic references correspond to statuses of the Hidden Markov Models. The language model 7 indicates the N gram probabilities. More particularly, a bigram or trigram language model is used.

For generating values for the acoustic references and for generating the language model, training phases are provided. Further explanations of the structure of the speech recognition system 1 may be learnt, for example, from WO 99/18556 whose contents are hereby included in this patent application.

Meanwhile there is extensive training material both for the formation of a language model and for the formation of an acoustic model. The invention relates to selecting those sections from the available training material which are optimal with respect to the application.

The selection of training data of the language model from available training material for generating a language model is shown in FIG. 2. A first text corpus 10 (background corpus C_{back}) represents the available training material. Customarily, this first text corpus 10 comprises a multitude of documents, for example, a multitude of newspaper articles. When an application-specific second text corpus 11 (C_{target}) is used, which contains text examples from the field of application of the speech recognition system 1, sections (documents) are now gradually removed from the first text corpus 10 to generate a reduced first text corpus 12 (C_{spez}); based on the text corpus 12 the language model 7 (LM) of the speech recognition system 1 is generated, which is better adapted to the field of application from which the second text corpus 11 is derived, than the language model which was generated on the basis of the background corpus 10. Customary procedures for generating the language model 7 from the reduced text corpus 11 are combined by the block 14. Occurrence frequencies of the respective N grams are evaluated and converted to probability values. These procedures are known and are therefore not further explained. A text corpus 15 is used for determining the end of the iteration to reduce the first training corpus 10.

The reduction of the text corpus 10 is carried out in the following fashion: Assuming that the text corpus 10 is composed of documents Aᵢ (i=1 . . . J) representing text corpus sections, the document Aᵢ is searched for in the first iteration step, which document maximizes the M-gram selection criterion

$$Δ {F}_{t , M} = {\sum }_{{x}_{M}} {N}_{spez} ( {x}_{M} ) log \frac{p ( {x}_{M} )}{{p}_{{A}_{i}} ( {x}_{M} )}$$

N_{spez}(x_{M}) is the frequency of the M-gram x_{M} in the application-specific text corpus 11, p(x_{M}) is the M-gram probability derived from the frequency of the M-gram x_{M} in the text corpus 10 and p_{A}, (x_{M}) is the M-gram probability derived from the frequency of the M-gram x_{M} in the text corpus 10 reduced by the text corpus section Aᵢ.

The relationship between a derived M-gram frequency N(x_{M}) and an associated probability value p(x_{M}) appears, for example, for so-called backing-off language models from the formula

$$p ( w \vert h ) ) = \frac{N ( w \vert h ) - d}{N ( h )} - β ( w \vert h ) ,$$

where an M-gram x_{M} is composed of a word w and an associated past h. d is a constant, β(w|h) is a correction value that depends on the respective M-gram.

After a document Aᵢ is determined in this manner, the text corpus 10 is reduced by this document. Starting from the thus generated reduced text corpus 10, documents Aᵢ are selected from the already reduced text corpus 10 in following iteration steps in corresponding fashion with the aid of said selection ΔF_{t,M}, and the text corpus 10 is gradually reduced by further documents Aᵢ. The reduction of the text corpus 10 is continued until a predefinable criterion for the reduced text corpus 10 is met. Such a criterion is, for example, the perplexity or the OOV rate (Out-Of-Vocabulary rate) of the language model that results from the reduced text corpus 10, which rate is preferably determined with the aid of the small text corpus 15. The perplexity and also the OOV rate reach a minimum via the gradual reduction of the text corpus 10 and again increase when the reduction is further continued. Preferably, the reduction is terminated when this minimum has been reached. The final text corpus 12 obtained from the reduction of the text corpus 10 at the end of the iteration is used as a basis for generating the language model 7.

Customarily, the tree structure, with words assigned to the tree edges and word frequencies assigned to its tree nodes, corresponds to a language model. In the case at hand such a tree structure is generated for the non-reduced text corpus 10. If the text corpus 10 is reduced by certain sections, adapted frequency values are determined with respect to the M-grams involved; an adaptation of the tree structure per se i.e. of the tree branches and ramifications, however, is not necessary and does not take place. After each evaluation of the selection criterion ΔF_{i,M} the associated adapted frequency values are erased.

As an alternative to the gradual reduction of a given background corpus, a text corpus used for generating language models may also be formed, so that, starting from a single section (=text document) of the background corpus, this document is gradually extended each time by another document of the background corpus to an accumulated text corpus in dependence of an application-specific text corpus. The sections of the background corpus used for the text corpus extension are determined in the individual iteration steps with the aid of the following selection criterion:

$$Δ {F}_{t , M} = {\sum }_{{x}_{M}} {N}_{spez} ( {x}_{M} ) log \frac{{p}_{{A}_{akk}} ( {x}_{M} )}{{p}_{{A}_{akk} + {A}_{i}} ( {x}_{M} )} .$$

P_{A}_{ₐₖₖ} (x_{M}) is the probability corresponding to the frequency of the M-gram x_{M} in an accumulated text corpus Aₐₖₖ, while the accumulated text corpus Aₐₖₖ is the combination of documents of the background corpus that are selected in previous iteration steps. In the actual iteration step the document Aᵢ of the background corpus, which document is not yet contained in the accumulated text corpus, is selected for which ΔF_{i,M} is maximal; with the accumulated text corpus used Aₐₐₖ this is combined to an extended text corpus which is used as a basis for an accumulated text corpus in the next iteration step. The index Aₐₖₖ+Aᵢ refers to the combination of a document Aᵢ with the accumulated text corpus Aₐₖₖ of the actual iteration step. The iteration is stopped if a predefinable selection criterion (see above) is met, for example, if the combination Aₐₖₖ+Aᵢ formed in the actual iteration step leads to a language model that has minimal perplexity.

When the acoustic model 6 is generated, corresponding approaches are used i.e. in a variant of embodiment those speech utterances of speech utterances (acoustic training material) available in the form of feature vectors are successively selected that lead to an optimized application-specific acoustic model with the associated corresponding acoustic references. However, also the reverse is possible, that is that parts of the given acoustic training material are gradually accumulated to form the acoustic references finally used for the speech recognition system.

The selection of acoustic training material is effected as follows:

xᵢ refers to all the feature vectors contained in the acoustic training material, which feature vectors are formed by feature extraction in accordance with the procedures carried out in block 3 of FIG. 1 and are combined to classes (for example corresponding to phonemes or phoneme segments or triphones or triphone segments). Cⱼ is then a set of observations of a class j in the training material. Cⱼ particularly corresponds to a certain state of a Hidden Markov Model or for this purpose corresponds to a phoneme or phoneme segment. Wₖ then refers to the set of all the observations of feature vectors in the respective training utterance k, which may consist of a single word or a word sequence. Nₖ^{J} then refers to the number of observations of class j in a training speech utterance k. Furthermore, yᵢ refers to the observations of feature vectors of a set of predefined application-specific speech utterances. The following formulae assume Gaussian distributions with respective mean values and covariances.

For a class Cⱼ a mean value vector is defined

$${μ}_{j} = \frac{1}{{N}_{j}} {\sum }_{i ∈ {C}_{j}} {x}_{i}$$

Removing the speech utterance k from the training material produces a change of the mean value relating to class Cⱼ of

$${μ}_{j}^{k} = \frac{1}{{N}_{j} - {N}_{k}^{j}} [ {N}_{j} {μ}_{j} - {\sum }_{i ∈ \{ {C}_{j} \} , i ∈ \{ {W}_{k} \}} {x}_{i} ]$$

As a result of the reduction of the acoustic training material by the speech utterance k, there is now a change value of

$$Δ {F}_{k}^{′} = {\sum }_{j} {\sum }_{i ∈ {T}_{j}^{k}} [ - \frac{1}{2} ( {y}_{i} - {μ}_{j}^{k} ) t \frac{1}{\sum } ( {y}_{i} - {μ}_{j}^{k} ) + \frac{1}{2} {( {y}_{i} - {μ}_{j} )}^{t} \frac{1}{\sum } ( {y}_{i} - {μ}_{j} ) ] ,$$

if unchanged covariance values are assumed. The value Σ is calculated as follows:

$$\sum = \frac{1}{N} {\sum }_{i} {( {x}_{i} - μ )}^{t} ( {x}_{i} - μ )$$

with N as the number of all the feature vectors in the non-reduced acoustic training material and μ as the mean value for all these feature vectors.

Basically, this change value is already a possibility as a criterion for the selection of speech utterances by which the acoustic training material is reduced. Also the change of covariance values should be taken into consideration. The covariances are defined by:

$${\sum }_{j} = \frac{1}{N} {\sum }_{i ∈ {C}_{j}} {( {x}_{i} - {μ}_{j} )}^{t} ( {x}_{i} - {μ}_{j} ) .$$

After the speech utterance k is removed from the training material, there is a covariance of

$${\sum }_{j}^{k} = \frac{1}{{N}_{j} - {N}_{k}^{j}} [ {N}_{j} {\sum }_{j} - {\sum }_{i ∈ \{ {C}_{j} \} , i ∈ \{ {W}_{k} \}} {( {x}_{i} - {μ}_{j} )}^{t} ( {x}_{i} - {μ}_{j} ) ] ,$$

so that, finally, a change value (logarithmic probability value) of

$$Δ {F}_{k} = {\sum }_{j} {\sum }_{i ∈ {T}_{j}^{k}} [ - \frac{1}{2} log det ( {\sum )}_{j}^{k} - \frac{1}{2} {( {y}_{i} - {μ}_{j}^{k} )}^{t} \frac{1}{{\sum }_{j}} ( {y}_{i} - {μ}_{j}^{k} ) + \frac{1}{2} log det ( {\sum }_{j} ) + \frac{1}{2} {( {y}_{i} - {μ}_{j} )}^{t} \frac{1}{{\sum }_{j}^{k}} ( {y}_{i} - {μ}_{j} ) ]$$

is the result, which value is then used as a selection criterion. The acoustic training material is gradually reduced each time by a part that corresponds to the selected speech utterance k, which is expressed in a respectively changed mean value μⱼ^{k} and a respectively changed covariance Σⱼ^{k} for the respective class j in accordance with the formulae described above. The mean values and covariances obtained at the end of the iteration and relating to the speech utterances still occurring in the training material are used for forming the acoustic references (block 8) of the speech recognition system 1. The iteration is stopped when a predefinable interrupt criterion is met. For example, in each iteration step the word error rate of the speech recognition system is determined for the appearing acoustic model and a test speech entry (word sequence). If the resulting word error rate is sufficiently small, or if a minimum of the word error rate is reached, the iteration is stopped.

Another approach to forming the acoustic model of a speech recognition system starts from a given part of acoustic training material, which part represents a speech utterance and which material represents a multitude of speech utterances, is gradually extended by one or more other parts of the given acoustic training material and that by means of the accumulated parts of the given acoustic training material the acoustic references of the acoustic model are formed. With this approach a speech utterance k is determined in each iteration step, which utterance maximizes a selection criterion ΔFₖ′ or ΔFₖ in accordance with the formulae defined above. In lieu of gradually reducing given acoustic training material, respective parts of the given acoustic training material that correspond to a single speech utterance are accumulated, that is, in each iteration step by the respective, part of the given acoustic training material, which part corresponds to a single speech utterance k. The formulae for μⱼ^{k} and Σⱼ^{k} must then be modified as follows

$${μ}_{j}^{k} = \frac{1}{{N}_{J} + {N}_{k}^{J}} [ {N}_{J} {μ}_{J} + {\sum }_{t ∈ \{ {C}_{j} \} , i ∈ \{ {W}_{k} \}} {x}_{i} ] ;$$

$${\sum }_{J}^{k} = \frac{1}{{N}_{J} + {N}_{k}^{j}} [ {N}_{J} {\sum }_{J} + {\sum }_{i ∈ \{ {C}_{j} \} , i ∈ \{ {W}_{k} \}} {( {x}_{i} - {μ}_{j} )}^{t} ( {x}_{i} - {μ}_{j} ) ] .$$

The other formulae may be used without any changes.

The approaches described for forming the acoustic model of a speech recognition system are basically suitable for all types of clustering for mean values and covariances and all types of covariance modeling (for example, scalar, diagonal matrix, full matrix). The approaches are not restricted to Gaussian distributions, but may also be described, for example, in Laplace distributions.

1. A method of generating a language model (7) for a speech recognition system (1), characterized
in that a first text corpus (10) is gradually reduced by one or various text corpus parts in dependence on text data of an application-specific second text corpus (11) and
in that the values of the language model (7) are generated on the basis of the reduced first text corpus (12) is used.

2. A method as claimed in claim 1, characterized in that for determining the text corpus parts by which the first text corpus (10) is reduced, unigram frequencies in the first text corpus (10), in the reduced first text corpus (12) and in the second text corpus (11) are evaluated.

3. A method as claimed in claim 2, characterized in that for determining the text corpus parts, by which the first text corpus (10) in a first iteration step and accordingly in further iteration steps is reduced, the following selection criterion is used:
$$Δ {F}_{i , M} = {\sum }_{{x}_{M}} {N}_{spez} ( {x}_{M} ) log \frac{p ( {x}_{M} )}{{p}_{{A}_{i}} ( {x}_{M} )}$$
with N_{spez}(x_{M}) as the frequency of the M-gram x_{M} in the second text corpus, p(x_{M}) as the M-gram probability derived from the frequency of the M-gram x_{M} in the first training corpus and p_{A}, (x_{M}) as the M-gram probability derived from the frequency of the M-gram x_{M} in the first training corpus reduced by the text corpus part Aᵢ.

4. A method as claimed in claim 3, characterized in that trigrams are used as a basis with M=3 or bigrams with M=2 or unigrams with M=1.

5. A method as claimed in one of the claims 1 to 4, characterized in that a test text (15) is evaluated to determine the end of the reduction of the first training corpus (10).

6. A method as claimed in claim 5, characterized in that the reduction of the first training corpus (10) is terminated when a certain perplexity value is reached or a certain OOV rate of the test text, especially when a minimum is reached.

7. A method of generating a language model (7) for a speech recognition system (1), characterized in that a text corpus part of a given first text corpus is gradually extended by one or various other text corpus parts of the first text corpus in dependence on text data of an application-specific text corpus to form a second text corpus and in that the values of the language model (7) are generated while the second text corpus is used.

8. A method of generating an acoustic model (6) for a speech recognition system (1), characterized
in that acoustic training material representing a first number of speech utterances is gradually reduced by training material parts representing individual speech utterances in dependence on a second number of application-specific speech utterances and
in that the acoustic references (8) of the acoustic model (6) are formed by means of the reduced acoustic training material.

9. A method of generating an acoustic model (6) for a speech recognition system (1), characterized in that a part of given acoustic training material, which material represents a multitude of speech utterances, is gradually extended by one or more other parts of the given acoustic training material and in that the acoustic references (8) of the acoustic model (6) are formed by means of the accumulated parts of the given acoustic training material.

10. A speech recognition system comprising a language model generated in accordance with one of the claims 1 to 7 and/or an acoustic model generated in accordance with claim 8 or 9.
